(19) United States
(12) Patent Application Publication
(10) Pub. No.: US 2006/0005958 A1
(43) Pub. Date: Jan. 12, 2006

(54) Air conditioning unit for vehicle use

(75) Inventor: Kenichiro Maeda, Neyagawa-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/167,457

(22) Filed: Jun. 27, 2005

(30) Foreign Application Priority Data
Jun. 29, 2004 (JP) 2004-191216(PAT.)

(51) Int. Cl. B60H 3/00; B60H 1/00; F28F 27/02

(52) U.S. Cl. 165/202; 165/86; 165/103; 165/42

(57) ABSTRACT

The rotary shaft 6 is provided in the first end portion 5a of the heater core 4, and the first end portion 5a is arranged so that it can be contacted with the inner wall 1b of the case 1a of the air conditioning unit 10. In the state of Max Cool (M/C), the heater core 4 is arranged so that the rotary angle θ can be the minimum value (=0) at which the heater core 4 is contacted with the inner wall of the case and the second end portion 5b opposed to the first end portion comes close to the evaporator 3. In the state of Max Hot (M/H), the heater core is arranged so that the rotary angle θ can be increased to a value at which the second end portion is contacted with the inner wall of the case. In the state of air-mixing in which the rotary angle is set at an intermediate value, almost all of the blast of cold air flowing into the region 5d can pass through the heater core since no leakage of air is caused in the first end portion. Due to the foregoing, the air-mixing space located on the downstream side of the rotating heater core can be made to come close to the heater core and the air-mixing property can be enhanced.

### BACKGROUND OF THE INVENTION

1. Field of the Invention

The present invention relates to an air conditioning unit for vehicle use.

2. Description of the Related Art

There has been conventionally provided an air-mixing type air conditioning unit, for vehicle use, in which an air-mixing door is not used but a heat exchanger (a heater core) itself is rotated so as to conduct air-mixing. Concerning this type air conditioning unit for vehicle use, refer to the official gazettes of JP-A-2001-47845 and JP-A-2001-246921.

According to the prior art disclosed in the above official gazettes, as shown in FIG. 1, as the heat exchanger 4 is rotated round the rotary shaft 6 from Max Cool position M/C to Max Hot position M/H, the heat exchanger 4 comes close to the evaporator 3 arranged on the upstream side of the heat exchanger 4. Accordingly, the ventilating area is not decreased in all states from the time of M/C to the time of M/H. Therefore, it is possible to provide an air conditioning unit with a low draft loss even if the air conditioning unit is arranged in a restricted space.

However, according to the above prior art, the following problems may be encountered. In the case where the heat exchanger 4 is rotated through an intermediate angle between M/C and M/H, the air-mixing space 8, in which a blast of cold air and a blast of hot air are mixed with each other on the downstream side, is formed at a position distant from the heat exchanger 4 on the downstream side of the heat exchanger 4, that is, the air-mixing space 8 is formed at a position close to the vehicle room blowout port switching space (mode switching space) 9 located on the downstream side of the heat exchanger 4. Therefore, the air-mixing property, by which a blast of cold air and a blast of hot air are mixed with each other, is deteriorated at the air blowout port (DEF, FACE and FOOT).

### SUMMARY OF THE INVENTION

In view of the above points, the present invention has been accomplished. It is an object of the present invention to enhance the air-mixing property when the air-mixing space, which is located on the downstream side of the rotating heat exchanger, is close to the heat exchanger.

In order to achieve the above object, an air conditioning unit (10) for vehicle use of the present invention comprises: a ventilating passage (1) having a blower (2) on the upstream side of the air flow and having a blowout port (7a, 7b, 7c) on the downstream side of the air flow; and a heat exchanger (4) arranged in the ventilating passage being capable of rotating round a rotary shaft (6), a volume of air, which is sent from the upstream side, passing through the heat exchanger being increased according to an increase in the rotary angle (θ), heat being exchanged with the air passing through the heat exchanger so as to adjust a temperature of the air on the downstream side, wherein the heat exchanger (4) includes a first (5a) and a second end portion (5b) arranged opposite to each other in the perpendicular direction of the rotary shaft (6), a clearance between the first end portion and the inner wall of the ventilating passage is maintained to be a minute value irrespective of a change in the rotary angle, and the second end portion is located on the upstream side of the rotary shaft when the rotary angle is the minimum value.

According to the present invention, in the ventilating passage, the heat exchanger is arranged at a position on the upstream side of the rotary shaft when the second end portion, which is the other end portion, is set at the minimum rotary angle at which the volume of air passing through the heat exchanger becomes minimum under the condition that the clearance between the first end portion and the inner wall of the ventilating passage is maintained at the minimum value in the first end portion which is one end portion in the direction perpendicular to the rotary shaft, that is, under the condition that the air seldom leaks out from between the first end portion and the ventilating passage inner wall.

Accordingly, in the case of a rotary angle larger than the minimum value of the rotary angle of the heat exchanger, a blast of air, which is sent from the upstream side and collides with the heat exchanger, positively passes through the heat exchanger without escaping along the surface of the heat exchanger so that heat can be exchanged. The blast of air which has passed through the heat exchanger in this way, can be sufficiently mixed with air which has not passed through the heat exchanger on the second end portion side, in the air-mixing space formed in the neighborhood of the heat exchanger on the downstream side. Accordingly, the downstream side of the air-mixing space can be made compact, and the air conditioning unit can be downsized.

An air conditioning unit (10) for vehicle use of the present invention comprises: a ventilating passage (1) having a blower (2) on the upstream side of the air flow and having a blowout port (7a, 7b, 7c) on the downstream side of the air flow; and a heat exchanger (4) arranged in the ventilating passage being capable of rotating round a rotary shaft (6), a volume of air, which is sent from the upstream side, passing through the heat exchanger being increased according to an increase in the rotary angle (θ), heat being exchanged with the air passing through the heat exchanger so as to adjust a temperature of the air on the downstream side, wherein the heat exchanger (4) includes a first (5a) and a second end portion (5b) arranged being opposed to each other in the perpendicular direction of the rotary shaft, the rotary shaft is arranged in the first end portion, and the second end portion is located on the upstream side of the rotary shaft when the rotary angle is the minimum value.

According to this invention, in the ventilating passage, the heat exchanger includes a rotary shaft in the first end portion which is one end portion. The second end portion, which is the other end portion in the direction perpendicular to the rotary shaft, is arranged on the upstream side of the rotary shaft when the rotary angle of the heat exchanger is set at the minimum rotary angle at which a volume of air passing through the heat exchanger becomes minimum.

Accordingly, in the case where the rotary angle of the heat exchanger is larger than the minimum value, a blast of air colliding with the heat exchanger from the upstream side can pass through the heat exchanger and exchange heat. In this way, a blast of air, which has passed through the heat exchanger, can be sufficiently mixed with a blast of air, which has not passed through the heat exchanger on the second end portion side, in the air-mixing space formed in the neighborhood of the heat exchanger on the downstream side. Accordingly, the downstream side of the air-mixing space can be made compact, and the air conditioning unit can be downsized.

In this case, the first end portion is composed so that the clearance between the first end portion and the inner wall of the ventilating passage can be maintained at a minute value irrespective of a change in the rotary angle. Due to the foregoing, the leakage of air, which is sent from the upstream side, from the first end portion to the downstream side can be restricted to be minimum. Accordingly, a volume of air passing through the heat exchanger can be maximized.

The heat exchanger of the present invention can be formed into a rectangle, the parallel sides, opposed to each other, of which are the first and the second end portion.

The heat exchanger of the present invention can be made to be a heat exchanger (4) used for heating to heat air when air sent from the upstream side passes through the heat exchanger. In this case, when the rotary angle of the heat exchanger (heater core) used for heating becomes minimum, it is the Max Cool state in which a volume of air passing through the heater core becomes the minimum value, and when the rotary angle of the heat exchanger (heater core) used for heating becomes maximum, it is the Max Hot state in which a volume of air passing through the heater core becomes the maximum value.

A heat exchanger (3) used for cooling can be arranged in the ventilating passage on the upstream side of the heat exchanger used for heating. At this time, when a rotary angle of the heat exchanger used for heating is increased, the second end portion of the heat exchanger for heating is moved to the downstream side. Therefore, the entire heat exchanger used for heating is substantially separated from the heat exchanger used for cooling.

Accordingly, in the case where a rotary angle of the heat exchanger used for heating is increased at the time of maximum heating, the heat exchanger used for heating does not come close to the heat exchanger for cooling. Therefore, when condensed water attached to the heat exchanger for cooling is scattered to the downstream side by an air flow, it is possible to reduce a quantity of water arriving at the heat exchanger for heating. Accordingly, it is possible to prevent a rise in the humidity of blowout air which is caused by evaporation of the water attached to the heat exchanger for heating.

Therefore, it is possible to prevent misting of a window in a blowout space.

In this connection, reference marks in parentheses for each means described above correspond to the specific means described in the embodiment shown later.

The present invention may be more fully understood from the description of preferred embodiments of the invention, as set forth below, together with the accompanying drawings.

### BRIEF DESCRIPTION OF THE DRAWINGS

In the drawings:

FIG. 1 is a view showing a relation between the rotary angle of the heater core and the air-mixing space of the prior art;

FIG. 2 is a view showing a relation between the rotary angle of the heater core and the air-mixing space of the present invention;

FIG. 3 is a graph showing a relation between the degree of opening of air-mixing and the average air temperature in the air-mixing region;

FIG. 4(a) is a view showing a variation of the first embodiment;

FIG. 4(b) is a view showing another variation of the first embodiment;

FIG. 5 is a view showing still another variation of the first embodiment;

FIG. 6 is a view showing an outline of the arrangement of the air conditioning unit of the second embodiment;

FIG. 7 is a sectional view showing an arrangement of the heater core pipe portion of the second embodiment; and

FIG. 8 is a view showing an outline of the arrangement of the heater core driving portion, wherein the view is taken in the direction B in FIG. 7.

### DESCRIPTION OF THE PREFERRED EMBODIMENTS

### First Embodiment

Referring to the drawings, the first embodiment, which is a typical embodiment for explaining the technical concept of the present invention, will be explained as follows. FIG. 2 is a sectional view showing an outline of the arrangement the ventilating passage 1 of the air conditioning unit 10 of the first embodiment.

In the case 1a of the ventilating passage 1, the evaporator 3, which is a heat exchanger for cooling, is arranged so that all of the blast of air, which is sent from a blower not shown arranged on the upstream side, can pass through the evaporator 3 and can be cooled by the evaporator 3.

On the downstream side of the evaporator 3, the rectangular heater core 4, which is a heat exchanger for heating, is arranged. The heater core includes a first end portion 5a and a second end portion 5b which are opposed to each other. The first end portion 5a is provided with a rotary shaft 6 and is arranged so that it can be substantially contacted with the inner wall (the inner wall 1e on the recess portion in FIG. 2) of the case 1a. The profile of the first end portion is formed into a semi-cylindrical shape along the rotary shaft 6.

The rotary shaft 6 is pivotally supported by the inner wall 1b on the lower side of the case 1a. The first end portion 5a is arranged so that the surface of the first end portion 5a can be substantially contacted with the inner wall 1e on the recess portion of the case 1a, that is, so that a clearance formed between the surface of the first end portion 5a and the inner wall 1e on the recess portion of the case 1a can be very minute. Accordingly, when the heater core 4 is rotated round the rotary shaft 6 by an actuator not shown, the clearance formed between the surface of the first end portion 5a and the inner wall 1e on the recess portion of the case 1a can be kept very minute.

It is possible to adopt an arrangement in which this clearance is made to be 0, that is, it is possible to adopt an arrangement in which the semi-cylindrical surface of the first end portion 5a is made to come into contact with the inner wall 1e on the recess portion of the case 1a and both are slid on each other at the time of rotation of the heat exchanger. In any case, it is possible to make a volume of air, which leaks out from between the first end portion 5a and the inner wall 1e on the recess portion of the case 1a to the downstream side, substantially zero.

The heater core 4 is arranged so that it can be rotated round the rotary shaft 6 and located at the position M/C when the rotary angle θ is minimum (for example, θ=0°) and at the position M/H when the rotary angle θ is maximum. At the position M/C, the second end portion 5b, which is opposed to the first end portion 5a in which the rotary shaft 6 is included, is located on the upstream side of the rotary shaft 6, that is, the second end portion 5b comes close to the evaporator 3. Therefore, the second end portion 5b becomes parallel with the inner wall 1b on the lower side of the case 1a. Accordingly, the air cooled by the evaporator 3 seldom passes through the heater core 4, and the temperature of the air cannot, substantially, be raised.

On the other hand, at the position M/H, the second end portion 5b is located at a position where the second end portion 5b is contacted with the upper side inner wall 1c opposed to the lower side inner wall 1b, on which the first end portion 5a and the rotary shaft 6 are arranged. Alternatively, the second end portion 5b is located at a position where a small clearance is formed between the second end portion 5b and the upper side inner wall 1c opposed to the lower side inner wall 1b. Due to the above arrangement, a volume of air, which leaks out from the first end portion 5a and the second end portion 5b, can be substantially made to be 0. Therefore, almost all of the air cooled by the evaporator 3 can pass through the heater core 4.

At this position M/H, the heater core 4 is arranged being separated from the evaporator 3 by at least the distance between the first end portion 5a and the second end portion 5b of the heater core 4. Due to the foregoing, at the time of M/H, that is, at the time of maximum heating, it is possible to prevent the occurrence of such a problem that the condensed water attaching to the evaporator 3 is scattered by an air flow and arrives at, and attaches to, the heater core 4. Accordingly, the humidity of the air blown out from the heater core 4 is not raised. Therefore, it is possible to prevent a window from being misted by the air of high humidity and high temperature.

There are provided a DEF air blowout port 7a, a FACE air blowout port 7b and a FOOT air blowout port 7c at the end portion on the downstream side of the heater core 4 of the ventilating passage 1. From these blowout ports, conditioned air, which has been subjected to air-mixing, is blown out into the vehicle compartment. In this connection, a switching door for switching the air blowout mode of each air blowout port is omitted in FIG. 2.

Next, explanations will be made into the air-mixing space 8 and the mode switching space 9 of this embodiment. The mode switching space 9 is a region in which the air flow is divided into the aforementioned air blowout ports 7a, 7b, 7c. On the other hand, the air-mixing space 8 is a region in which a blast of cold air CW1, which has not passed through the heater core 4, and a blast of hot air HW, which has passed through the heater core 4 and the temperature has been raised by the heat exchange with the heater core 4, are mixed with each other.

The air-mixing space 8 is formed when the rotary angle θ of the heater core 4 is an intermediate angle (0°<θ<maximum angle) between the minimum angle (the position M/C) and the maximum angle (the position M/H). This intermediate angle will be referred to as an angle at which the state A/M is formed.

In this embodiment, as shown in FIG. 2, when the rotary angle θ of the heater core 4 is an angle at which the state A/M is formed, the second end portion 5b is located at a position on the upstream side of the rotary shaft 6, that is, the second end portion 5b is located at a position close to the evaporator 3. Accordingly, the bypass passage 5c is formed between the second end portion 5b and the upper side inner wall 1c of the case 1a.

On the other hand, the clearance formed between the first end portion 5a and the inner wall 1e on the recess portion of the case 1a is maintained to be minute, or the clearance is substantially zero, irrespective of the rotary angle θ of the heater core 4. Therefore, a leakage of air flowing out from this minute clearance to the downstream side seldom occurs.

Accordingly, a blast of cold air CW1 flowing on the upper side of the second end portion 5b, which is in a blast of cold air sent from the evaporator 3 on the upstream side, passes through the bypass passage 5c and arrives at the downstream side of the heater core 4 without passing through the heater core 4.

On the other hand, a blast of cold air CW2 flowing on the lower side of the second end portion 5b, which is in a blast of cold air sent from the evaporator 3 on the upstream side, enters the space 5d formed between the heater core 4 and the lower side inner wall 1b of the case 1a. At this time, an angle formed between the heater core 4 and the lower side inner wall 1b is smaller than 90°. Further, the clearance between the first end portion 5a and the inner wall 1e on the recess portion is very minute or zero. Therefore, almost all of the blast of cold air CW2, which has entered the space 5d, passes through the heater core 4.

Heat is exchanged between the blast of cold air CW2, which passes through the heater core 4, and the heater core 4, so that the blast of cold air CW2 can be changed into a blast of hot air HW. This blast of hot air HW is mixed with the blast of cold air CW1, which is sent from the bypass passage 5c, in the space located right after the heater core 4. That is, the region on the downstream side of the heater core 4 becomes the air-mixing space 8.

A predetermined distance is formed in the air flowing direction from the air-mixing space 8 to the first end portion 5a, and a predetermined distance is also formed in the air flowing direction from the air-mixing space 8 to the rotary shaft 6. Further, the mode switching space 9 is located on the downstream side of the rotary shaft 6. Accordingly, the air-mixing space 8 and the mode switching space 9 are separated from each other by a relatively long distance. In other words, the air-mixing space 8 is formed at a position which is a relatively long distance away on the upstream side of the mode switching space 9.

Accordingly, the air-mixing space 8 can be substantially extended in the air flowing direction without extending the region between the evaporator 3 and the mode switching space 9. Due to the foregoing, the property of mixing cold air with hot air can be enhanced, and the occurrence of incomplete mixing can be suppressed in the mode switching space 9.

Since the air-mixing space 8 can be formed in the neighborhood on the downstream side of the heater core 4, the region between the evaporator 3 and the mode switching space 9 can be reduced while a draft resistance is being kept at the same value.

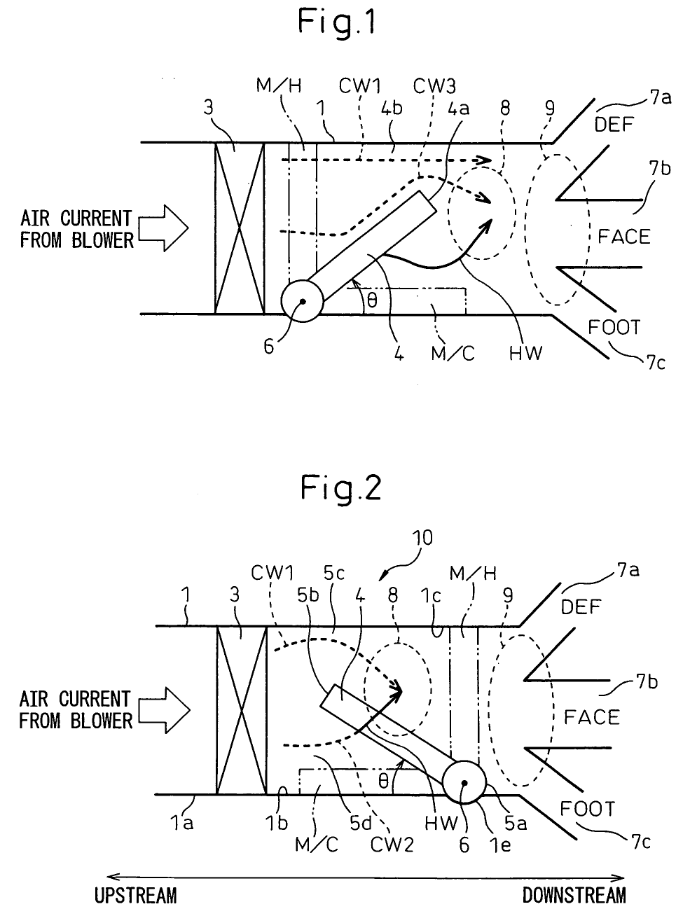

On the other hand, according to the prior art shown in FIG. 1, all of the blast of cold air flowing on the lower side of the end portion 4a on the upper side of the heater core 4, which is in a blast of cold air sent from the evaporator 3 on the upstream side, does not pass through the heater core 4. That is, although one portion of the blast of cold air passes through the heater core 4, another portion of blast of clod air CW3 does not pass through the heater core 4 but flows on the surface of the heater core 4 because the incident angle of the blast of cold air on the surface of the heater core 4 is large, and a flow of air tends to be formed from the end portion 4a on the upper side of the heater core 4 to the bypass passage 4b.

Blasts of cold air CW1 and CW3, which have passed through the bypass passage 4b, cannot be made to flow into the neighborhood on the downstream side of the heater core 4 but are mixed with a blast of hot air HW, which has passed the heater core 4, in the region distant from the heater core 4 on the downstream side. That is, according to the prior art, the air-mixing space 8 is formed in a region distant from the heater core 4 and is necessarily made to come close to the mode switching space 9.

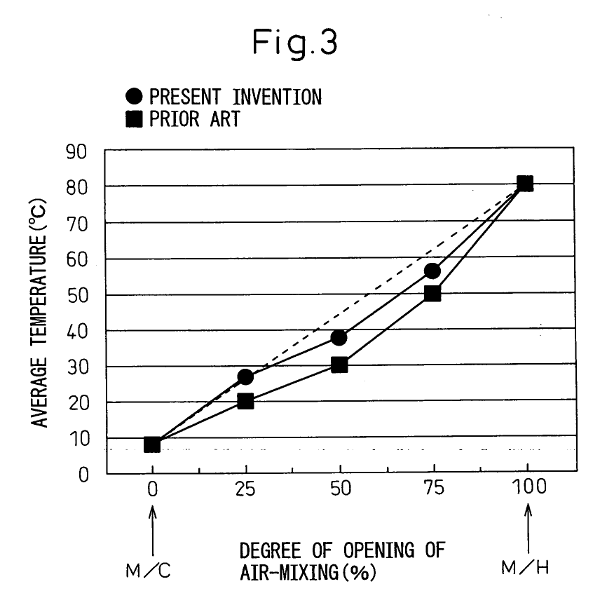

FIG. 3 is a graph showing a result of a simulation experiment which shows a relation between the degree of opening of air-mixing, which corresponds to the rotary angle θ of the heater core 4, and the average temperature of the air in the air-mixing space 8 in the embodiment (shown in FIG. 2) of the present invention and in the prior art (shown in FIG. 1).

As shown in FIG. 3, the average temperatures of this embodiment and the prior art at the points M/C and M/H are the same. However, concerning the average temperatures of this embodiment and the prior art at the point of the intermediate degree of opening of air-mixing, the average temperature of the prior art is lower than that of this embodiment. The reason is described as follows. At the angle at which the state A/M is formed, according to the prior art, a volume of air, which flows on the surface of the heater core 4 to the downstream side without flowing into the heater core 4, is large in the volume of cold air sent from the evaporator 3.

According to this embodiment, this volume of cold air flowing on the surface of the heater core 4 is so small that the curve of a blast of cold air sent from the evaporator 3 is close to the ideal line shown by the broken line in FIG. 3. Therefore, the linearity of temperature control is excellent. Due to the foregoing, the performance of controlling the degree of opening of air-mixing can be enhanced.

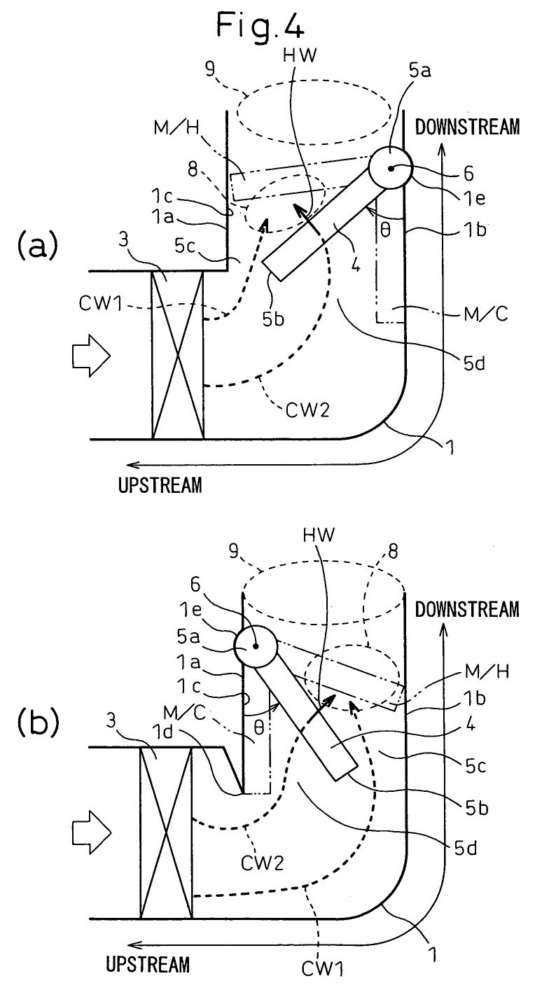

In this connection, in the first embodiment described above, the shape of the ventilating passage 1 is linear. However, it is possible to adopt an arrangement in which the position of the evaporator 3 and the position of the heater core 4 in the case 1 substantially meet at right angles with each other as shown in FIGS. 4(a) and 4(b). In this connection, the same reference characters are used to indicate like parts in FIG. 2, in which the first embodiment is shown, and FIGS. 4(a) and 4(b).

FIG. 4(a) shows an example in which the first end portion 5a of the heater core 4 and the rotary shaft 6 are provided on the inner wall 1b (inner wall 1e on the recess portion) of the case outside the bent portion of the ventilating passage 1, and FIG. 4(b) shows an example in which the first end portion 5a of the heater core 4 and the rotary shaft 6 are provided on the inner wall 1c (inner wall 1e on the recess portion) of the case inside the bent portion of the ventilating passage 1.

In any case, at the position M/C at which the rotary angle θ round the rotary shaft 6 of the heater core 4 is minimum, the surface of the heater core 4 comes into contact with the inner walls 1b or 1c of the case. At the position M/H at which the rotary angle θ is increased, the second end portion 5b of the heater core 4 comes into contact with the opposed inner walls 1c or 1b of the case. Due to the above structure, almost all of the blast of cold air, which is sent from the evaporator 3, can pass through the heater core 4.

In this connection, in the example shown in FIG. 4(b), in order to arrange the heater core 4 at a position on the upstream side as close as possible, the bent inner wall id, which includes a plane formed along the surface of the heater core 4 at the position M/C, is provided. Due to the above structure, it is possible to reduce a distance between the evaporator 3 and the heater 4, so that the air conditioning unit can be made smaller in size.

In the cases shown in FIGS. 4(a) and 4(b), the air-mixing space 8 is formed at a position close to the downstream side of the heater core 4, and a distance between the air-mixing space 8 and the mode switching space 9 in the air flowing direction can be extended, and the region of the air-mixing space 8 can be substantially extended. Accordingly, the property of air-mixing can be enhanced.

In the heater core 4 of the first embodiment, the rotary shaft 6 is arranged in the first end portion 5a. This does not necessarily mean that the rotary shaft 6 is provided only on the end portion of the heater core 4. That is, in FIGS. 4(a) and 4(b), the explanations are made in such a structure that the rotary shaft 6 is located at the central position of a circle of a predetermined radius. In other words, the rotary shaft 6 can be arranged at a neighborhood position in the range of a predetermined distance from the surface of the first end portion 5a of the heater core 4.

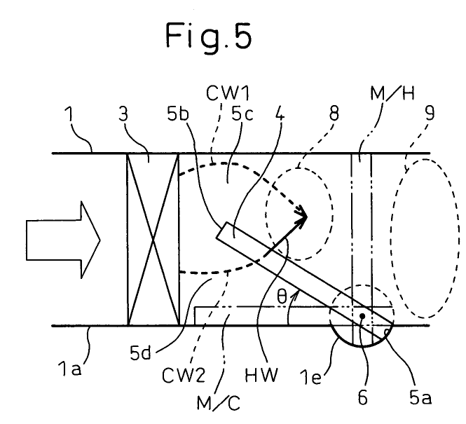

In this connection, the rotary shaft 6 may be arranged at a position distant from the surface of the first end portion 5a by a predetermined distance. FIG. 5 shows an example. In the example shown in FIG. 5, the rotary shaft 6 is arranged at a position distant from the end surface of the first end portion 5a by the distance of 10% to 20% of the length of the heater core 4 in the direction perpendicular to the rotary shaft 6. At this time, it is necessary that the first end portion 5a always comes into sliding contact with the recess portion inner wall 1e of the case 1a of the ventilating passage 1 when the heater core 4 is rotated. In this case, the clearance must be very minute. Due to the foregoing, a leakage of air from between the first end portion 5a and the case 1a to the downstream side can be suppressed, and all of the blast of cold air, which flows into the region 5d between the heater core 4 and the case 1a on the lower side of FIG. 5 can pass through the heater core 4.

### Second Embodiment

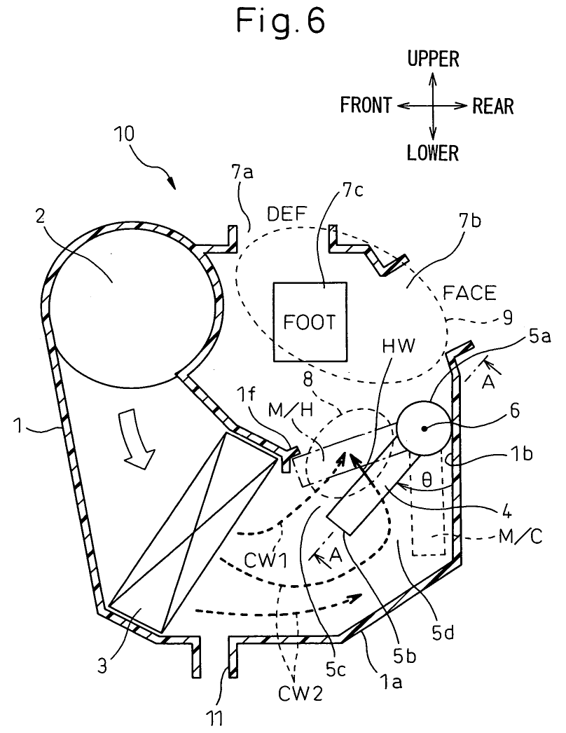

Next, the second embodiment of the present invention will be explained below. FIG. 6 is a view showing an outline of the arrangement of the air conditioning unit 10 of the second embodiment. In this connection, FIG. 6 is a view showing the air conditioning unit 10, which is arranged on a dashboard of a vehicle, wherein the view is taken from the left of the vehicle. Arrows in FIG. 6 indicate the directions of the front, the rear, the upper and the lower (up and down) of the vehicle.

In the front upper portion of the air conditioning unit 10, the centrifugal blower 2 is arranged. The blower 2 sends a blast of air introduced from the outside of the air conditioning unit 10 and forms an air current in the direction indicated by the arrows in FIG. 6. On the downstream side of the lower portion of the blower 2, the evaporator 3, which is a heat exchanger for cooling, is arranged. All of the air current sent from the blower 2 passes through the evaporator 3 composing the refrigerating cycle (not shown) and is cooled by the evaporator 3. The thus cooled air becomes cold air CW1, CW2 (shown by the broken lines in FIG. 6) and flows to the downstream side.

On the downstream side of the evaporator 3, the heater core 4, which is a heat exchanger used for heating in which engine coolant (hot water) circulates, is arranged so that the first end portion 5a can be contacted with the inner wall of the case 1a of the air conditioning unit 10. In the state of M/C, the heater core 4 is located so that it can be contacted with the inner wall 1b of the case 1a in the perpendicular lower direction in FIG. 6. In the state of M/H, the heater core 4 is rotated by the maximum angle and located so that the second end portion 5b of the heater core 4 can be contacted with the engaging portion if provided inside the air conditioning unit 10.

In this connection, in the second embodiment, the maximum rotary angle of the heater core 4, at which the state M/H is provided, is not necessarily 90°. For example, the maximum rotary angle of the heater core 4 may be 60° to 70°. Due to the foregoing, the length of the air conditioning unit 10 in the longitudinal direction of the vehicle can be reduced so that the air conditioning unit 10 can be made smaller in size.

When the rotary angle θ round the rotary shaft 6 of the heater core 4 is an intermediate angle, at which the state A/M is formed, between the minimum angle (=0) at the time of M/C and the maximum angle at the time of M/H, the air-mixing space 8 is formed in the neighborhood on the downstream side of the heater core 4. In this air-mixing space 8, a blast of cold air CW1, which passes through the bypass passage 5c and does not pass through the heater core 4, and a blast of hot air HW, which passes through the heater core 4 from the space 5d formed between the heater core 4 and the inner wall 1b, can be effectively mixed with each other.

In the second embodiment, the first end portion 5a of the heater core 4, in which the rotary shaft 6 is provided, is arranged so that it can be contacted with the inner wall 1b of the case 1a. Alternatively, the first end portion 5a of the heater core 4, in which the rotary shaft 6 is provided, is arranged so that a clearance formed between the first end portion 5a and the inner wall 1b of the case 1a is minute. Therefore, a volume of air leaking out from the first end portion 5a can be minimized. Accordingly, almost all of the blast of cold air CW2 entering the region 5d between the heater core 4 and the inner wall 1b of the case 1a can pass through the heater core 4. Due to the foregoing, the air-mixing space 8 can be formed in the neighborhood on the downstream side of the heater core 4.

The mode switching space 9 is formed on the downstream side (in the upper portion in FIG. 6) of the air-mixing space 8. A DEF blowout port 7a, a FACE blowout port 7b and a FOOT blowout port 7c are formed in this mode switching space 9 in the case 1a. In FIG. 6, the FOOT blowout port 7c is provided on the side portion of the case 1a (on the viewer's side of the drawing).

The drain 11 for discharging the condensed water, which is generated by the evaporator 3, to the outside of the air conditioning unit 10 is provided in the lower bottom portion of the case 1a. Even in the case where cooling water leaks out from the sliding portion of the heater core 4 described later, the leaking water can be discharged from this drain 11.

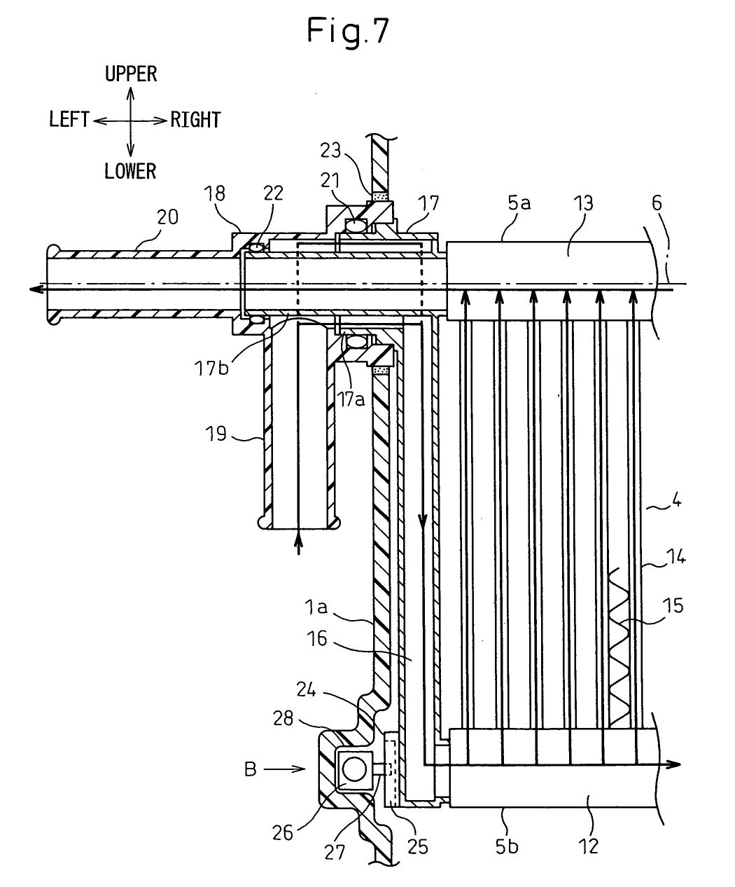

FIG. 7 is a view showing a portion of the section of the heater core 4 taken on line A-A in FIG. 7. In FIG. 7, only the neighborhoods of the inlet and outlet of the heater core 4 are shown and a portion of the section is shown being hatched. In the same manner as that of FIG. 6, arrows in FIG. 7 indicate the directions of the right, the left, the upper and the lower (up and down) of the vehicle.

As shown in FIG. 7, the heater core 4 includes: an inlet side header tank 12 extending in the traverse direction; an outlet side header tank 13 extending in the traverse direction; a large number of tubes 14 to communicate the header tank 12 with the header tank 13; and a large number of corrugated fins to connect the adjoining tubes 14. The shape of the header tank 13 is rectangular. The longitudinal direction of the outlet side header tank 13, which is the first end portion 5a, is arranged so that it can coincide with the rotary shaft 6. The inlet side header tank 12, which is the second end portion 5b, is formed in parallel with the longitudinal direction of the rotary shaft 6 and the outlet side header tank 13.

The connection pipe 16 extending in the direction of the outlet side header tank 13, in parallel with the tubes 14, is fixed to the left end portion of the inlet side header tank 12 and they communicate with each other. On the other hand, the left end portion of the outlet side header tank 13 is fixed to the rotary side pipe 17 having a concentric double pipe structure and they communicate with each other.

The rotary side pipe 17 is provided with an outside pipe 17a and an inside pipe 17b which are formed concentrically with the rotary shaft 6. The inside pipe 17b is fixed to, and communicates with, the outlet side header tank 13 in the direction of the rotary shaft 6. Between the outside pipe 17a and the outer circumference of the inside pipe 17b, the cooling water passage is concentrically formed and communicates with the connection pipe 16.

As described above, the rotary side pipe 17, the connection pipe 16 and the heater core 4 are fixed being integrated with each other into one body. In this connection, although not shown in the drawing, the rotary side pipe 17 and the connection pipe 16 may be made being divided into a plurality of members, and these members may be joined to each other into one body when the air conditioning unit 10 is assembled.

The stationary side pipe 18 is pivotally engaged with the outside pipe 17a and the inside pipe 17b of the rotary side pipe 17 so that the stationary side pipe 18 can be relatively rotated with respect to them round the rotary shaft 6. In the stationary side pipe 18, the outlet pipe 20 is provided being capable of communicating with the outlet side header tank 13 and the inside pipe 17b in the rotary shaft 6 direction. In the stationary side pipe 18, the inlet pipe 19 is formed so that it can communicate with only the outside pipe 17a in the outer circumferential portion of the inside pipe 17b of the rotary side pipe 17.

Between the rotary side pipe 17 and the stationary side pipe 18, a plurality of O-rings 21, 22 are engaged a round the rotary shaft 6. The plurality of O-rings 21, 22 respectively prevent a leakage of the cooling water from the inlet pipe 19 into the case 1a and a leakage of the cooling water from the inlet pipe 19 to the outlet pipe 20. The stationary side pipe 18 is fixed to the case 1a of the air conditioning unit 10 via the packing member 23. This packing member 23 prevents the cooling water from leaking out from the case 1a.

In this connection, the stationary side pipe 18 is fixed to the case 1a by a fixing member with screws. Accordingly, the rotary side pipe 17 engaging with the stationary side pipe 18 fixed to the case 1a can slide round the rotary shaft 6 via O-rings 21, 22 provided between the rotary side pipe 17 and the stationary side pipe 18. On the other hand, the end portion of the rotary shaft 6 on the right in the drawing not shown of the outlet side header tank 13 is pivotally held by a bearing (not shown) provided on the case 1a. As described above, when the stationary side pipe 18 is used as one of the bearings of the rotary shaft 6 and when the bearing provided on the case 1a on the other end side of the outlet side header tank 13 integrally connected to the rotary side pipe 17 is used as the other bearing of the rotary shaft 6, the heater core 4 can be rotated round the rotary shaft 6 between the bearings.

In this connection, in FIG. 7, the flowing direction of the cooling water in each pipe is shown by an arrow. The cooling water flowing from the inlet pipe 19 passes from the outer circumferential portion of the inside pipe 17b through the outside pipe 17a and reaches the connection pipe 16. This cooling water flows in the connection pipe 16 downward in the drawing and enters the inlet side header tank 12. In the inlet side header tank 12, the cooling water is divided into each tube 14 and flows into the outlet side header tank 13. When the cooling water flows in the tubes 14, a current of air flowing in the direction perpendicular to the surface of FIG. 7 conducts exchanging heat with the cooling water via the corrugated fins 15, so that the current of air can be heated.

As shown in FIG. 7, it is desirable that the inlet side header tank 12 is arranged in a lower portion of the outlet side header tank 13 in the perpendicular direction. The reason is that even when air is mixed in the pipe arranged from the inlet pipe 19 to the connection pipe 16, the cooling water can be made to flow smoothly upward in each tube 14.

Next, the driving method of rotating the heater core 4 will be explained below. In the second embodiment, the rotary shaft 6 provided in the first end portion 5a is not given a driving torque but the neighborhood of the second end portion 5b on the other end is driven in the circumferential direction so that the heater core 4 can be rotated round the rotary shaft 6.

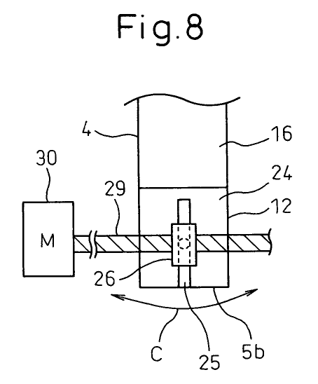

FIG. 8 is a view showing an outline of the structure of the portion close to the second end portion 5b of the heater core 4, wherein the view is taken in the direction B in FIG. 7. The guide member 24 is provided in the lower end portion on the side of the connection pipe 16. The groove 25, the length of which is predetermined, is formed in the guide member 24 in the longitudinal direction of the connection pipe 16, that is, in the cooling water flowing direction of the tube.

On the other hand, the screw 29 rotated by the actuator 30 in the normal and the reverse direction is fixed to the case 1a together with the actuator 30. The nut 26 is screwed to the screw 29 and restricted by the nut guide 28 provided in the case 1a as a recess portion. The nut 26 is moved in the traverse direction in FIG. 8 according to the rotation of the screw 29. The pin 27 is integrally provided in the nut 26 and engaged in the groove 25 of the guide member 24.

Due to the above structure, the screw 29 is rotated by the actuator 30. According to the rotation of the screw 29, the nut 26 is moved in the longitudinal direction of the screw 29. At this time, the pin 27 is moved together with the nut 26. However, by a component of the force given to the pin 27 in the direction of the groove 25, the pin 27 is moved so that the force can be relieved, and by a component of the force given to the pin 27 in the direction perpendicular to the groove 25, the guide member 24 is given a reaction force. By this reaction force, the guide member 24 and the inlet side header tank 12, which is the second end portion 5b, can be rotated round the rotary shaft 6 of the first end portion 5a in the direction of arrow C in FIG. 8.

Accordingly, the rotary angle of the heater core 4, that is, the degree of opening of air-mixing can be determined by a displacement of the nut 26 on the screw 29, that is, by the number of revolutions of the actuator 30.

While the invention has been described by reference to specific embodiments chosen for purposes of illustration, it should be apparent that numerous modifications could be made thereto by those skilled in the art without departing from the basic concept and scope of the invention.

1. An air conditioning unit for vehicle use comprising:
a ventilating passage having a blower on the upstream side of the air flow and having a blowout port on the downstream side of the air flow; and a heat exchanger arranged in the ventilating passage and capable of rotating round a rotary shaft, a volume of air, which is sent from the upstream side, passing through the heat exchanger being increased according to an increase in the rotary angle (θ), heat being exchanged with the air passing through the heat exchanger so as to adjust a temperature of the air on the downstream side, wherein
the heat exchanger includes a first end portion and a second end portion arranged being opposed to each other in the perpendicular direction of the rotary shaft,
a clearance between the first end portion and the inner wall of the ventilating passage is maintained to be a minute value irrespective of a change in the rotary angle, and
the second end portion is located on the upstream side of the rotary shaft when the rotary angle is the minimum value.

2. An air conditioning unit for vehicle use comprising:
a ventilating passage having a blower on the upstream side of the air flow and having a blowout port on the downstream side of the air flow; and a heat exchanger arranged in the ventilating passage and capable of rotating round a rotary shaft, a volume of air, which is sent from the upstream side, passing through the heat exchanger being increased according to an increase in the rotary angle (θ), heat being exchanged with the air passing through the heat exchanger so as to adjust a temperature of the air on the downstream side, wherein
the heat exchanger includes a first end portion and a second end portion arranged opposed to each other in the perpendicular direction of the rotary shaft,
the rotary shaft is provided in the first end portion, and
the second end portion is located on the upstream side of the rotary shaft when the rotary angle is the minimum value.

3. An air conditioning unit for vehicle use according to claim 2, wherein the first end portion is composed so that the clearance between the first end portion and the inner wall of the ventilating passage can be maintained at a minute value irrespective of a change in the rotary angle.

4. An air conditioning unit for vehicle use according to claim 1, wherein the heat exchanger is formed into a rectangle, the parallel sides opposed to each other being the first end portion and the second end portion.

5. An air conditioning unit for vehicle use according to claim 1, wherein the heat exchanger is a heat exchanger used for heating to heat air when air sent from the upstream side passes through the heat exchanger.

6. An air conditioning unit for vehicle use according to claim 5, wherein a heat exchanger used for cooling is arranged in the ventilating passage on the upstream side of the heat exchanger used for heating.
